(19) United States
(12) Patent Application Publication
(10) Pub. No.: US 2026/0094894 A1
(43) Pub. Date: Apr. 2, 2026

(54) Battery Module Assembly Method Using Conformal Installation of Cooling Interface

(71) Applicant: Lithos Energy, Inc., Hayward, CA (US)

(72) Inventors: Robert Wayne Sweney, Oakland, CA (US); Greg Nichols, Lafayette, CA (US); Elliot Hu, Hayward, CA (US)

(21) Appl. No.: 18/904,811

(22) Filed: Oct. 2, 2024

(51) Int. Cl. H01M 10/6554; H01M 10/613; H01M 10/643; H01M 50/213; H01M 50/262

(52) U.S. Cl. CPC H01M 10/6554; H01M 10/613; H01M 10/643; H01M 50/213; H01M 50/262

(57) ABSTRACT

A method for installing a cooling interface on a battery module is disclosed. The method includes partially installing battery cells into individual battery cell frames. Positioning a cooling plate, with adhesive on an upper surface of the cooling plate, atop the partially inserted battery cells, with the surface having the adhesive thereon facing toward the battery cells. Pressing each battery cell into each individual battery cell frame with the cooling plate. As the cooling plate presses the battery cells into the individual battery cell frames, the individual battery cells adjust to the surface of the cooling plate. The disclosure also provides a battery module with a cooling interface. The battery module includes battery cells installed in individual battery cell frames. A cooling plate has a top surface which is non-flat. The cooling plate is connected to the battery cell frames and the battery cells by a uniformly thick layer of adhesive.

### TECHNICAL FIELD

This disclosure relates to battery modules and specifically to installing cooling mechanisms on battery modules.

### BACKGROUND

Lithium based batteries achieve their maximum electrical performance and durability within a limited temperature range. This temperature range is generally between 20° C. and 30° C. As temperatures rise above 30° C., the cell oxidation rate increases, which causes faster degradation of the battery, decline in performance, and reduced capacity of the battery. Lithium batteries operated at temperatures over 40° C. may lead to permanent battery damage. Maintaining the temperature of the battery between 20° C. and 30° C. increases the efficiency, life, and safety of the battery.

### SUMMARY

In a first aspect, the disclosure provides a method for installing a cooling interface on a battery module. The method includes partially installing battery cells into individual battery cell frames. Positioning a cooling plate, with adhesive on an upper surface of the cooling plate, atop the partially inserted battery cells, with the surface having the adhesive thereon facing toward the battery cells. Pressing each battery cell into each individual battery cell frame with the cooling plate. As the cooling plate presses the battery cells into the individual battery cell frames, the individual battery cells adjust to the surface of the cooling plate.

In a second aspect, the disclosure provides a battery module with a cooling interface. The battery module with a cooling interface comprises battery cells installed in individual battery cell frames. A cooling plate, the cooling plate having a top surface which is non-flat. The cooling plate is connected to the battery cell frames and the battery cells by a uniformly thick layer of adhesive.

In a third aspect, the disclosure provides a battery module frame with a cooling interface. The battery module frame with a cooling interface comprises a frame block of connected individual battery cell frames. A cooling plate, the cooling plate having a top surface which is non-flat. The cooling plate is connected to the frame block by a uniformly thick layer of adhesive.

Further aspects and embodiments are provided in the foregoing drawings, detailed description and claims.

### BRIEF DESCRIPTION OF THE DRAWINGS

The following drawings are provided to illustrate certain embodiments described herein. The drawings are merely illustrative and are not intended to limit the scope of claimed inventions and are not intended to show every potential feature or embodiment of the claimed inventions. The drawings are not necessarily drawn to scale; in some instances, certain elements of the drawing may be enlarged with respect to other elements of the drawing for purposes of illustration.

FIG. 1 is a side view of a modular battery frame with battery cells partially installed in individual battery cell frames.

FIG. 2 is a side view of a modular battery frame with battery cells partially installed in individual battery cell frames, and a cooling plate placed atop the battery cells.

FIG. 3 is a side view of a modular battery frame with battery cells pressed into place in individual battery cell frames by a cooling plate. The battery cells having adjusted to the cooling plate.

FIG. 4 is a bottom-up view of a modular battery frame.

FIG. 5 is a bottom perspective view of a modular battery frame.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

Lithium based batteries achieve their maximum electrical performance and durability within a limited temperature range. This temperature range is generally between 20° C. and 30° C. Batteries generate heat. The heat may be generated due to internal resistance, current flow, or electrochemical reactions. Raising the temperature of batteries and the environment around them may result in decreased performance. Cooling batteries or the environment in which they are being used may maintain or improve performance. Batteries are often placed in locations where heat is easily built up. To cool batteries a cooling plate may be attached to battery cells.

Cooling plates transfer heat from the battery cells into the cooling plate. The manufacture of cooling plates may not result in surfaces which are entirely flat. The cooling plate is typically composed of two sheets assembled in a sandwich construction. Between the two sheets are channels through which coolant is circulated. The two sheets are typically constructed of materials which transfer heat. Metals are good conductors, aluminum and copper are especially well suited for use due to light weight, excellent thermal conductivity, and cost-effectiveness. The channels may be formed in the sheets that make up the cooling plate in any number of ways, including stamping, machining, or welding. The sheets may then be joined together by one of roll bonding, diffusion bonding, ultrasonic welding, brazing, or cold welding. Any of these methods may result in the surface of the sheet being irregular or non-flat. The sheets may be machined or sanded flat, however flattening the sheet may be expensive and time consuming. Maximizing the contact of the cooling plate with the battery cells increases thermal performance. A non-flat surface of a sheet of the cooling plate may reduce contact of the battery cells with the cooling plate and therefore the effectiveness of the cooling plate.

Battery cells are grouped into modules for several reasons. One reason is to improve safety. By grouping the cells together, it is easier to contain any leakage of electrolyte. Additionally, any fire will be isolated into a smaller group. Further, modules can be equipped with sensors and controls that can help to prevent safety hazards. Another reason to group cells into modules is to improve efficiency. By connecting the cells in series, the voltage of the battery pack can be increased. By connecting the cells in parallel, the capacity of the battery pack can be increased. This allows battery packs to be tailored to the specific needs of an application. Grouping cells into modules can make them easier to manufacture and assemble. Modules can be pre-assembled and tested before being integrated into a larger battery pack. This can help to improve the quality and reliability of battery packs.

Battery cells are often cylindrical in shape. Cylindrical shapes for battery cells offer some advantages including good mechanical stability and ease of manufacture. The cylindrical shape distributes pressure evenly throughout the cell. This makes them structurally strong and able to withstand the buildup of internal pressure during operation. This is important for safety, as it reduces the risk of leaks or ruptures. Cylindrical cells are relatively simple to manufacture using automated processes. This makes them a cost-effective option, especially for mass production. The winding process for the electrodes within the cell is well-established and allows for consistent quality. The cylindrical shape allows for better air circulation around the cell, which helps to keep it cool. This is important because heat can degrade battery performance and lifespan. Cylindrical cells can better handle swelling caused by gas buildup during charging and discharging cycles.

However, disadvantages of cylinders include the necessity to provide a frame to hold the cylinders because a cylinder is less stable when positioned on one end. The electrodes are generally positioned at the top of the battery cell. Connections between the electrodes are therefore at the top of the of each battery cell. Movement at the top of the battery cells can lead to broken electrical connections. Most battery pack designs, and particularly those designed for cylindrical battery cells utilize adhesives or mechanical retention devices which are located away from the top of the battery cell. Adhesives are heavy, expensive, hard to control, and often have a slow cure time. All these detriments to adhesives affect the speed at which a battery pack is assembled. Mechanical retention away from the top of the cell, offers less mechanical rigidity to the top of the cell, which is detrimental because most of the electrical connections attach at the top of the cell, where the electrodes are positioned, if the battery cells are not held rigidly in place connections between the cells can be difficult to establish, or can be broken if the cells shift.

A frame can be used to hold the battery cells in place. Each battery cell requires its own frame, a battery cell holding frame. Each battery cell holding frame comprises an enclosure which surrounds a cavity into which a battery cell fits. In some implementations, the frame may extend the full length of the battery cell. In some other implementations, the frame may be in two portions, an upper portion which encompasses and supports the top of a battery cell and a lower portion which encompasses and supports the bottom of the battery cell.

In some implementations, the battery cell holding frames are arranged in rows. In some implementations, the battery cell holding frames are arranged in rows of between three and sixteen battery cell holding frames. In some implementations, the rows are further arranged into multiple rows to create a frame block. In some implementations, the frame blocks are arranged between three rows and sixteen rows. In some implementations, a frame block may be arranged from three rows of three frames to twelve rows of twelve frames. In some implementations, a frame block is arranged in eight rows of twelve battery cell holding frames. In some implementations, the frame blocks are further arranged into modular battery frames. In some implementations, the modular battery frame is constructed of multiple frame blocks. Any number of battery frame blocks may be combined to create modular battery frames of any size.

The addition of a cooling plate increases the efficiency of the battery module. To install a cooling plate, battery cells are partially inserted into individual battery cell frames. A cooling plate is positioned atop the partially inserted battery cells. Adhesive is placed on the top surface of the cooling plate. The surface having the adhesive thereon facing toward the battery cells. The cooling plate with the adhesive is pressed onto the battery cells. Each battery cell is pressed into each individual battery cell frame with the cooling plate. As the cooling plate presses the battery cells into the individual battery cell frames, the individual battery cells adjust to the surface of the cooling plate. The adhesive connects the cooling plate to the battery cells and to the battery cell frames.

The individual battery cell frames hold the battery cells in position. The individual battery cell frames allow the battery cells to move vertically. Additionally, some horizontal or tilting movement is allowed as well. As the cooling plate presses against the battery cells and presses them into the battery cell frames, the battery cells adjust to the surface of the sheet of the cooling plate with which the battery cells are in contact. As the battery cells are pressed into the battery cell frames, the battery cells will be pressed to the depth of the portion of the plate with which they are in contact. For example, if there is a divot in the sheet of the cooling plate, the battery cells in contact with the divot will be pressed less deeply into the battery cell frames, than the battery cells which are in contact with a portion of the sheet of the cooling plate that are lacking a divot. In another example, if there is a ridge in the sheet of the cooling plate, the battery cells in contact with the ridge will be pressed more deeply into the battery cell frames than battery cells which are not in contact with the ridge on the sheet of the cooling plate.

The adhesive spread on the surface of the cooling plate is wetted out to a minimum bond distance. The adhesive needs to be able to hold the battery cells and the battery cell frames in contact with the cooling plate. The smallest amount of adhesive used the better the cooling plate will be able to transfer heat from the battery cells. Adhesives are generally non-conductive and interfere with the transfer of heat from the battery cells to the cooling plate. The lower the distance between the cooling plate and the battery cells, the better the conductivity, and ability of the cooling plate to remove heat from the battery cells.

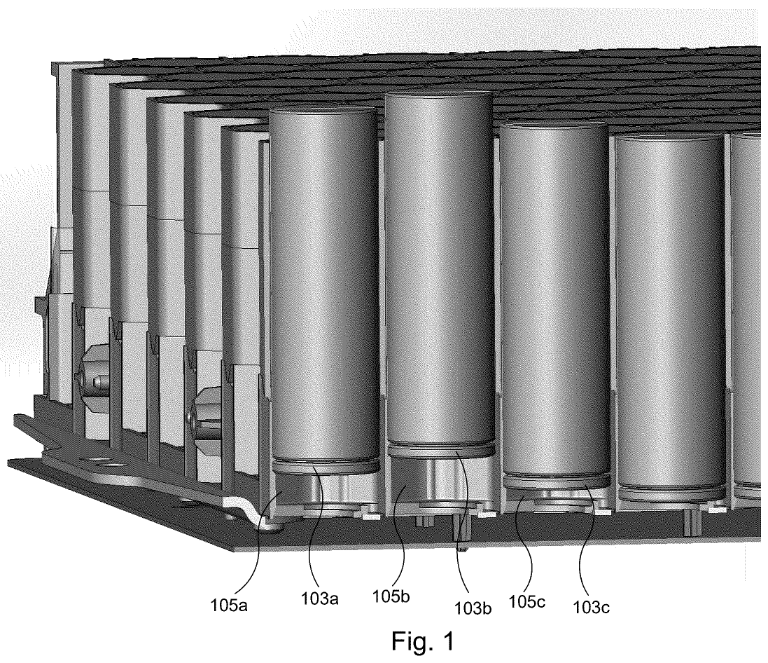

Now referring to FIG. 1, which is a side view of a battery module with some of the individual battery cell frames cut away to view the battery cells partially installed in the battery cell frames. Battery cells 103a, 103b, and 103c are partially installed in individual battery cell frames 105a, 105b, and 105c. The individual battery cell frames include elements which come in contact with the battery cells. These elements hold the battery cells securely, once the battery cells are pushed fully within the individual battery cell frames and include crush ribs and flex walls. As the battery cells are inserted in each individual battery cell frame, the crush ribs and flex wall of each individual battery cell frame prevent the battery cells from sliding into the battery cell frames and hold the battery cells in the partially installed position. The crush ribs and flex wall may not hold the battery cells to identical heights. Battey cell 103b is held higher in individual battery cell frame 105b than battery cells 103a and 103c are held in individual battery cell frames 105a and 105c.

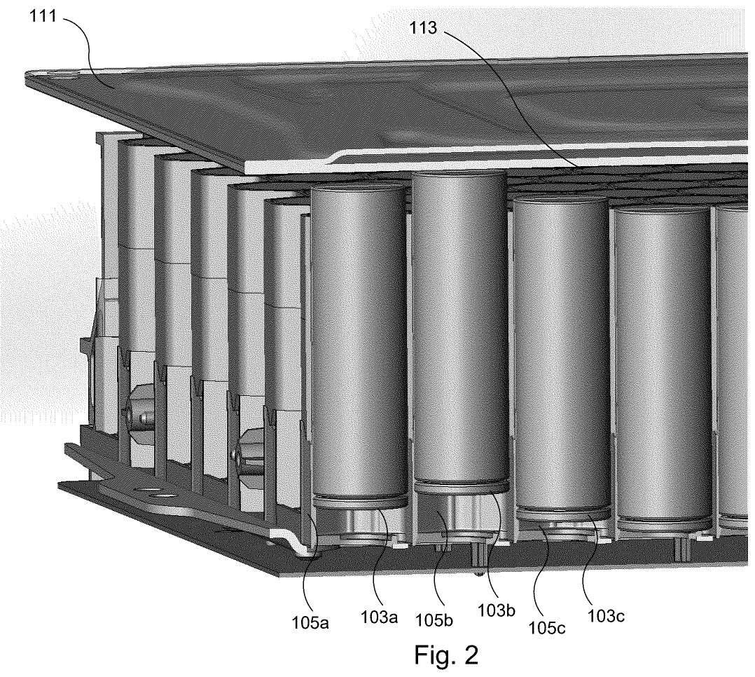

Now referring to FIG. 2, which is a side view of a battery module with some of the individual battery cell frames cut away to view the battery cells partially installed in the battery cell frames and the cooling plate positioned atop the partially installed battery cells.

Adhesive is added to a top surface of the cooling plate. Adhesive 113 is placed on the top surface of the cooling plate which comes in contact with the battery cells. The cooling plate 111 is placed atop the partially installed battery cells in preparation to push the battery cells into the battery cell frames. The adhesive secures the battery cells to the cooling plate. Pressure is applied to the cooling plate. That pressure is transferred to the battery cells. The cooling plate may have protruding imperfections, these perfections will come in contact with the battery cells and begin to press those battery cells into the individual battery cell frames. The surface of the cooling plate will then come in contact with the battery cells and press the battery cells into the individual battery cell frames. Finally, any recessed imperfections in the surface of the cooling plate come in contact with corresponding battery cells and the battery cells associated with the recessed imperfections are pushed into the individual cell frames. Battery cell 103c contacts a raised portion of the cooling plate 111 and is pushed into individual battery cell frame 105c. Battery cell 103a contacts the cooling plate at the average surface of the cooling plate and is pushed into the individual battery cell frame 105a. Battery cell 103b contacts a recess in the cooling plate and is pushed into individual battery cell frame 105b. As the battery cells are pushed by the cooling plate, the battery cells conform to the surface of the cooling plate. Battery cell 103c is pushed farthest into the battery cell frame 105c. Battery cell 103b is pushed the shortest distance into the battery cell frame 105c.

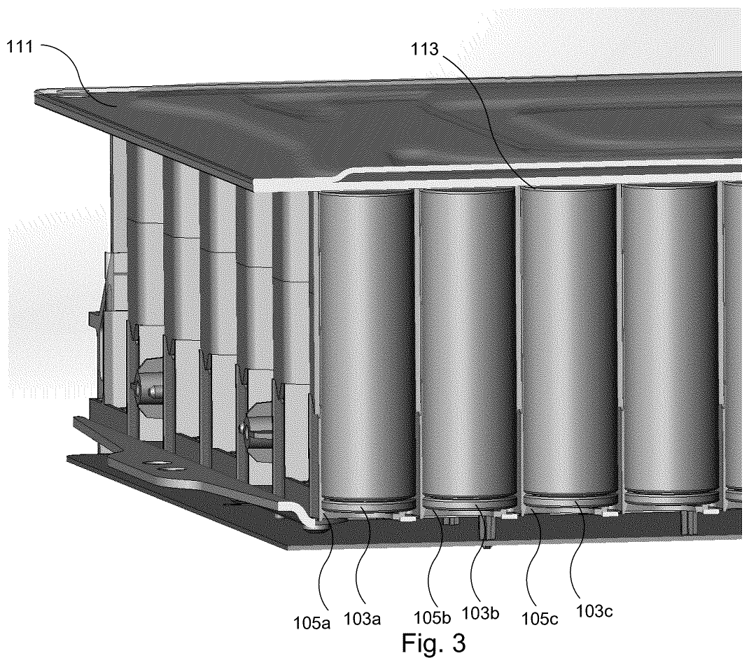

Now referring to FIG. 3, which is a side view of a battery module with some of the individual battery cell frames cut away to view the battery cells installed in their individual battery cell frames. Pressing the battery cells into the individual battery cell frames overcomes the resistance provided by crush ribs and the flex wall. The adhesive on the cooling plate is pressed to a minimum bond line distance between the battery cells and the cooling plate. Adhesive can interfere with conduction of heat. Poor conduction of heat would reduce the ability of the cooling plate to transfer the heat from the battery cells. The battery cells being able to move vertically in their individual battery cell frames enables the adhesive to establish and maintain a consistent bond line distance.

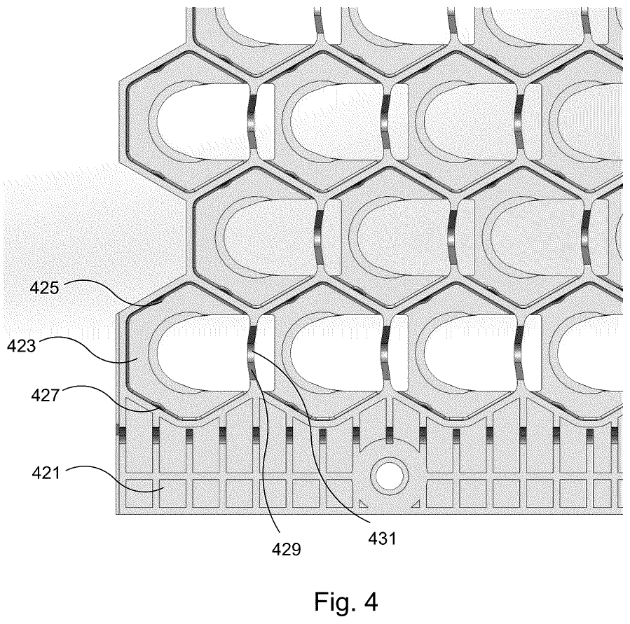

Now referring to FIG. 4, which is a bottom-up view of a multicell frame 421 for holding battery cells. The frame includes individual battery cell holding frames which form battery cell cavities, such as cavity 423 for holding battery cells. The individual cell frames are connected together to form the multicell frame, as each individual battery cell holding frame defines a cavity, the multicell frame defines multiple cell cavities. One advantage of hexagonal cell frames is the ability of the hexagons to stack, and to have all the cell frames be identically oriented. Two of the side walls include crush ribs, such as crush ribs 425 and 427, and one wall is a flex wall such as flex wall 429. The crush ribs are positioned so that they are on side walls with one wall between the side walls on which the crush ribs are positioned and the flex wall. The crush ribs are positioned about one hundred and twenty degrees from the center of the flex wall. The flex wall is designed to impart a radial force on a battery cell placed in the cell cavity. The flex wall arcs from one of the side walls adjacent to the flex wall to the other side wall adjacent to the flex wall. The flex wall can be tuned to provide sufficient force on the battery cell. In addition to flexing to accommodate a battery cell, the flex wall includes a notch in the wall, such as notch 431. This notch allows battery cells to be pushed into the cell cavity without the cell being perfectly positioned to enter the cavity. In practice this means that a battery cell could be misaligned relative to either the horizontal or to the vertical orientation of the cell cavity and the battery cell will still slide into the cavity without becoming hung up on the bottom edge of the flex wall of the individual cell frame.

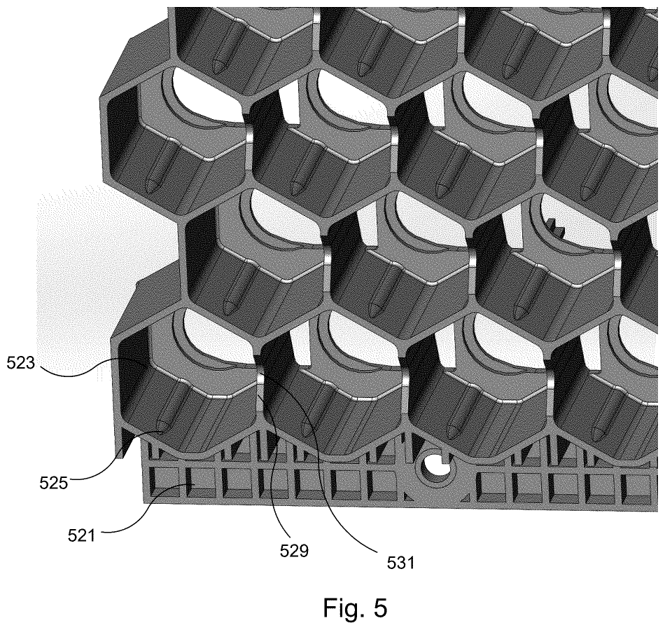

Referring now to FIG. 5 which is an isometric view of the frame 521 from the bottom of the frame. The frame includes multiple individual cell frames which define individual cell cavities, such as cell cavity 523. Each frame includes six walls. Two of the walls include crush ribs such as crush rib 525. The other crush rib is located on another wall and there is one wall between the walls with the crush ribs. The crush ribs, such as crush rib 525 are designed with a taper. The taper is pointed down, or toward the direction in which the battery cells are inserted into the cell cavity. The crush ribs assist in holding the battery cell in place. The taper on the crush ribs assists in getting the battery cell in place. The taper of the crush ribs also allows the battery cell to be inserted in a less than perfect orientation without getting hung up on the crush ribs. In addition to the taper of the crush ribs, the notches, such as notch 531 in the flex walls, such as flex wall 529 allow the battery cells to be inserted in less than perfect orientation. These features allow the battery cells to be inserted in less than perfect orientation, this can mean that the battery cells are not perfectly oriented with the battery cell cavities. This less than perfect orientation can be in the horizontal axis where the battery cell is aligned closer to one wall instead of directly through the middle of the cell cavity. This less than perfect orientation can also be in the vertical axis where the battery cell is not perfectly aligned vertically with the side walls of the frame. For example, the walls of the battery cell frame can be thought of as at zero degrees, the battery cell can be inserted starting at up to ten degrees off from the alignment with the walls of the battery cell frame.

The invention has been described with reference to various specific and preferred embodiments and techniques. Nevertheless, it is understood that many variations and modifications may be made while remaining within the spirit and scope of the invention.

What is claimed is:

1. A method for installing a cooling interface on a battery module comprising:
partially installing battery cells into individual battery cell frames;
positioning a cooling plate, with adhesive on an upper surface of the cooling plate, atop the partially inserted battery cells, with the upper surface having the adhesive thereon facing toward the battery cells;
pressing each battery cell into each individual battery cell frame with the cooling plate;
wherein as the cooling plate presses the battery cells into the individual battery cell frames, the individual battery cells adjust to the surface of the cooling plate.

2. The method of claim 1, wherein the cooling plate is non-flat.

3. The method of claim 1, wherein the cooling plate comprises two or more metal plates joined together.

4. The method of claim 3, wherein the cooling plate is formed by one of roll bonding, diffusion bonding, ultrasonic welding, brazing, or cold welding.

5. The method of claim 1, wherein the adhesive on the upper surface of the cooling plate is wetted out to a minimum bond line distance.

6. The method of claim 5, wherein the minimum bond line distance is established by placing a spacer bead between the cooling plate and the frame block.

7. The method of claim 1, wherein the individual battery cell frames further comprise elements which interact with the individual battery cells.

8. A battery module with a cooling interface comprising:
battery cells installed in individual battery cell frames;
a cooling plate, the cooling plate having a top surface which is non-flat;
wherein the cooling plate is connected to the battery cell frames and the battery cells by a uniformly thick layer of adhesive.

9. The battery module of claim 8, wherein the individual battery cells adjust to the top surface of the of the cooling plate.

10. The battery module of claim 9, wherein the individual battery cells adjust vertically, within the individual battery cell frames.

11. The battery module of claim 10, wherein the cooling plate comprises at least two metal plates.

12. The battery module of claim 9, wherein the adhesive is wetted out to a minimum bond line distance.

13. The battery module of claim 12, wherein the minimum bond line distance is established by placing a spacer bead between the cooling plate and the frame block.

14. A battery module frame with a cooling interface comprising:
a frame block comprising connected individual battery cell frames;
a cooling plate, the cooling plate having a top surface which is non-flat;
wherein the cooling plate is connected to the frame block by a uniformly thick layer of adhesive.

15. The battery module frame of claim 14, wherein the individual battery cells adjust to the top surface of the cooling plate.

16. The battery module frame of claim 15, wherein the individual battery cells adjust vertically within the individual battery cell frames.

17. The battery module frame of claim 16, wherein the cooling plate comprises two metal plates.

18. The battery module of claim 15, wherein the individual battery cell frames comprise battery cell holding elements.

19. The battery module frame of claim 15, wherein the adhesive is wetted out to a minimum bond line distance.

20. The battery module frame of claim 18, wherein the minimum bond line distance is established by placing a spacer bead between the cooling plate and the frame block.
